(19) United States
(12) Patent Application Publication
(10) Pub. No.: US 2014/0124489 A1
(43) Pub. Date: May 8, 2014

(54) Hybrid Welding Method of Laser Welding and Arc Welding for T-Joint

(71) Applicants: Xudong Zhang, Tokyo (JP); Eiji Ashida, Tokyo (JP); Shoh Tarasawa, Hitachi (JP); Yukihiro Soga, Hitachi (JP)

(72) Inventors: Xudong Zhang, Tokyo (JP); Eiji Ashida, Tokyo (JP); Shoh Tarasawa, Hitachi (JP); Yukihiro Soga, Hitachi (JP)

(73) Assignee: Hitachi, Ltd., Chiyoday-ku, Tokyo (JP)

(21) Appl. No.: 14/129,121

(22) PCT Filed: May 18, 2012
(86) PCT No.: PCT/JP2012/062803

§ 371 Date: Dec. 24, 2013

(30) Foreign Application Priority Data
Jun. 27, 2011 (JP) 2011-141691

(51) Int. Cl. B23K 28/02

(52) U.S. Cl. CPC B23K 28/02
USPC 219/121.64; 219/137 R

(57) ABSTRACT

A hybrid welding method of laser welding and arc welding for a T-joint in which a rib as one member to be welded abuts orthogonally onto a surface of a flange as other member to be welded includes forming a groove portion on a lateral surface of the rib that is an abutting part between the rib and the flange forming the T-joint; forming a flat part at a bottom part of the groove portion formed in the abutting part between the rib and the flange; and performing a hybrid welding using both laser welding in which the groove portion A with this flat part therein is irradiated with a laser beam, and arc welding, to form weld beads of weld metal in the groove portion A, so that welding together the flange and the rib forming the T-joint.

### TECHNICAL FIELD

The present invention relates to a hybrid welding method of laser welding and arc welding for a T-joint in which two members are joined together to form a T-joint.

### BACKGROUND ART

The shape of a welded joint formed by joining two metal members together varies depending on shape and performance requirements of the product. An example of joining a plate member and other plate member together is a T-joint having a configuration in which, on the surface of one plate member (hereinafter referred to as a flange), other plate member (hereinafter referred to as a rib) is placed.

This T-joint is often formed by joining by arc welding. However, arc welding has problems of low welding speed and large distortion.

Thus, laser welding which uses a laser beam with higher energy intensity than arc, and laser-arc hybrid welding which uses both a laser beam and arc are recently used for welding T-joints.

FIGS. 4 and 7 of Japanese Patent Laid-open No. 2008-272826 (Patent Literature 1) disclose laser-only welding in which laser welding is performed to form a groove shape where there is no gap between a flange and a rib that form a T-joint, and FIGS. 9 and 10 disclose a technique of welding in which laser-arc hybrid welding, using both laser welding and arc welding, is performed at a groove between the flange and the rib.

Japanese Patent Laid-open No. 2006-224137 (Patent Literature 2) discloses a technique of welding combining laser welding and arc welding in which a single beveled or J-type groove is provided in a gap between a flange and a rib that form a T-joint, laser welding is performed at a root part of the single beveled or J-type groove, and arc welding is performed at an enlarged opening portion of the single beveled or J-type groove.

FIG. 2 of Japanese Patent Laid-open No. 2009-82980 (Patent Literature 3) discloses a technique of welding combining laser welding and arc welding in which arc welding is performed for joining on one side of a groove shape where there is no gap between a flange and a rib that form a T-joint, and laser welding is performed as finishing welding on the other side of the groove shape between the flange and the rib.

### CITATION LIST

### Patent Literature

Patent Literature 1: Japanese Patent Laid-open No. 2008-272826

Patent Literature 2: Japanese Patent Laid-open No. 2006-224137

Patent Literature 3: Japanese Patent Laid-open No. 2009-82980

### SUMMARY OF INVENTION

### Technical Problem

By the way, with the technique of welding combining laser welding and arc welding as disclosed in Japanese Patent Laid-open No. 2006-224137, if a groove is not provided at the abutting part between the flange and the rib of a T-joint having a rib with a thickness of about a dozen mm or greater, the plate thickness with which the abutting part between the flange and the rib of the T-joint is fused for junction is limited. Therefore, a single beveled groove or J-type groove is provided to perform welding at the abutting part between the flange and the rib of the T-joint.

However, in the welding method combining laser welding and arc welding in which a single beveled groove or J-type groove is provided in the T-joint, there is a problem that the penetration depth at the welded part is insufficient and therefore a welded part with stable penetration depth cannot be provided.

This is because the local groove shape near a laser irradiating position 6 which irradiates a laser beam 3 for laser welding (the point of action between the laser beam 3 and an object to be welded) has an acute angle at a V part above a groove root part 41, as shown in FIG. 4 of a comparative example, and therefore, with surface tension, the molten metal by laser irradiation is pulled to the sidewall of the V part above the groove root part 41 and this molten metal is prevented from flowing backward in the welding direction.

Consequently, there is a problem that the amount of molten metal in the laser irradiation increases, and therefore the penetration depth at a welded part 7 that is formed from the laser irradiating position 6 as a starting point becomes shallow, as shown in FIG. 5 of a comparative example, and the penetration shape of the welded part 7 becomes unstable.

Thus, it is possible to increase the above penetration depth at the welded part 7 by increasing the laser output or decreasing the welding speed. However, in this case, there is a problem that an increase in the amount of energy consumed due to the increase in the laser output or a fall in welding efficiency due to the decrease in the welding speed is caused.

An object of the invention is to provide a hybrid welding method of laser welding and arc welding for a T-joint in which the increase in the amount of energy consumed and the fall in welding efficiency are avoided, thus achieving deep penetration on the bonding surface between the flange and the rib of the T-joint, and acquiring a welded joint with a stable penetration shape.

### Solution to Problem

A hybrid welding method of laser welding and arc welding for a T-joint according to the invention, in which a rib as are member to be welded abuts orthogonally onto a surface of a flange as other member to be welded, the method is characterized by: forming a groove portion on a lateral surface of the rib that is an abutting part between the rib and the flange forming the T-joint; forming a flat part at a bottom part of the groove portion formed in the abutting part between the rib and the flange; and performing a hybrid welding using both laser welding in which the groove portion with this flat part therein is irradiated with a laser beam, and arc welding, to form a weld bead of weld metal in the groove portion, so that welding together the flange and the rib forming the T-joint.

Also, a hybrid welding method of laser welding and arc welding for a T-joint according to the invention, in which a rib as one member to be welded abuts orthogonally onto a surface of a flange as other member to be welded, the method is characterized by: forming a groove portion on each of lateral surfaces on both sides of the rib that is an abutting part between the rib and the flange forming the T-joint; forming a flat part at a bottom part of the two groove portions formed in the abutting part between the rib and the flange; and performing a hybrid welding using both laser welding in which the two groove portions with these flat parts therein are irradiated with a laser beam, and arc welding, to form a weld bead of weld metal in each of the two groove portions, so that welding together the flange and the rib forming the T-joint.

A hybrid welding method of laser welding and arc welding for a T-joint according to the invention, in which a rib as one member to be welded abuts orthogonally onto a surface of a flange as other member to be welded, the method is characterized by: forming a groove portion on a lateral surface of the rib that is an abutting part between the rib and the flange forming the T-joint; forming the groove portion formed in the abutting part between the rib and the flange, with an arcuate part and an inclined surface having an inclination angle continuing to the arcuate part; and performing a hybrid welding using both laser welding in which the groove portion formed with the arcuate part and the inclined surface continuing to the arcuate part is irradiated with a laser beam, and arc welding, to form a welded part in which a weld bead is formed in the groove portion, so that welding together the flange and the rib forming the T-joint.

### Advantageous Effect of Invention

According to the invention, a hybrid welding method of laser welding and arc welding for a T-joint in which an increase in the amount of energy consumed and a fall in welding efficiency are avoided, thus achieving deep penetration on the bonding surface between the flange and the rib of the T-joint, and acquiring a welded joint with a stable penetration shape, can be realized.

### BRIEF DESCRIPTION OF DRAWINGS

FIG. 1 is a schematic view showing a T joint as a welding target in a first embodiment of the present invention.

FIG. 2 is a schematic view showing the groove shape of the T-joint in the first embodiment of the present invention.

FIG. 3 is a schematic view showing the result of welding the T-joint in the first embodiment of the present invention.

FIG. 4 is a schematic view showing the groove shape of a T-joint in a comparative example.

FIG. 5 is a schematic view showing the result of welding the T-joint in the comparative example.

FIG. 6 is a schematic view showing the groove shape of a T-joint in a second embodiment of the present invention.

FIG. 7 is a schematic view showing the result of welding the T-joint in the second embodiment of the present invention.

FIG. 8 is a schematic view showing the groove shape of a T-joint in a third embodiment of the present invention.

FIG. 9 is a schematic view showing the result of welding the T-joint in the third embodiment of the present invention.

### DESCRIPTION OF EMBODIMENTS

A hybrid welding method of laser welding and arc welding for a T-joint as an embodiment of the present invention will be described in detail with reference to the drawings.

### Embodiment 1

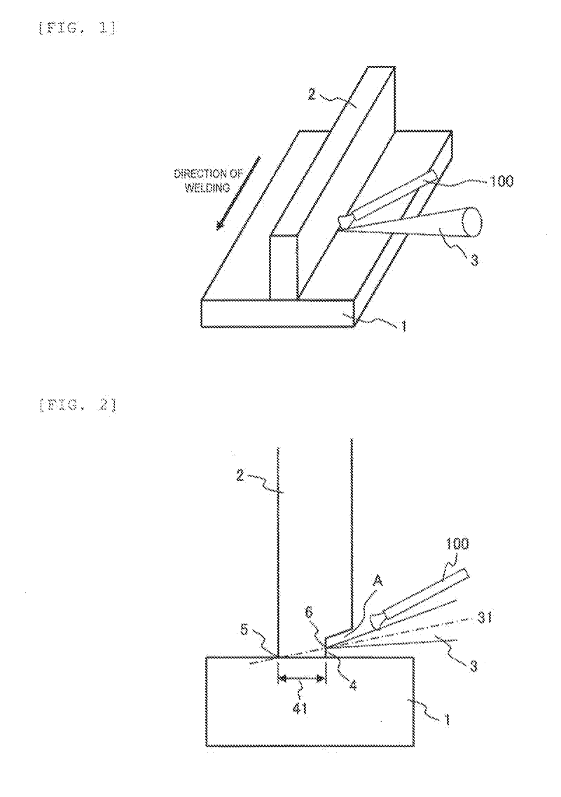

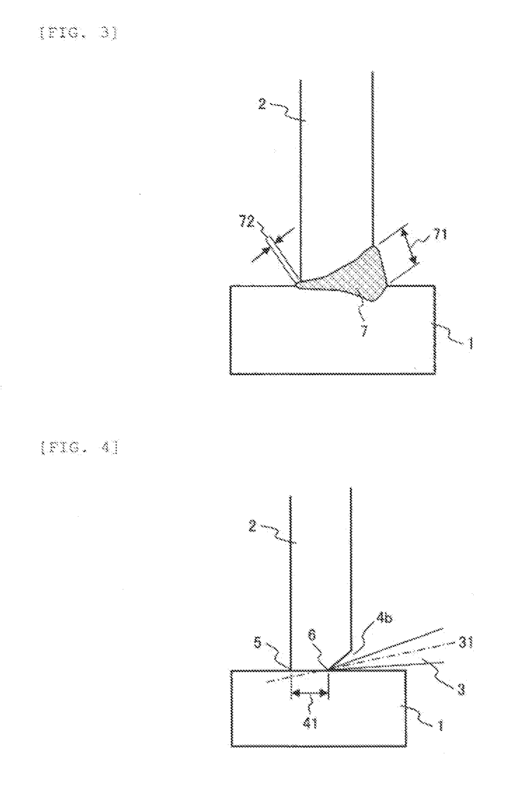

A hybrid welding method of laser welding and arc welding for a T-joint as a first embodiment of the present invention will be described in detail, using FIGS. 1 and 2.

FIG. 1 shows a T-joint as an object to be welded in a hybrid welding method of laser welding and arc welding for a T-joint as the first embodiment of the present invention.

The object to be welded is a T-joint including a mild steel plate member forming a rib 2 that is 400 mm long×200 mm wide×20 mm thick welded onto a mild steel plate member forming a flange 1 that is 400 mm long×400 mm wide×20 mm thick.

As the welding to join the flange 1 and the rib 2 to each other to from the T-joint, laser-arc hybrid welding that uses both a laser beam 3 and an arc 100 is carried out. By the way, the arrow indicates the direction of welding.

FIG. 2 shows the groove shape of an abutting part between the flange 1 and the rib 2 of the T-joint as an object to be welded in the hybrid welding method of laser welding and arc welding for the T-joint as the first embodiment of the present invention.

In FIG. 2, a flat part 4 in a groove portion A where the flat part 4 is provided in a bottom part as the abutting part between the flange 1 and the rib 2 of the T-joint is formed by mechanical processing in another process, not shown.

An experiment confirms that if the width of the flat part 4 in the groove portion A where the flat part 4 is provided in the bottom part as the abutting part between the flange 1 and the rib 2 of the T-joint is 1 mm or smaller, a deep penetration shape unique to laser welding cannot be obtained stably. Also, in order to fuse and joint the abutting part between the flange 1 and the rib 2 as in the target T-joint of the present invention, a laser needs to be irradiated on the side of the rib 2 at an angle with the surface of the flange 1.

Therefore, the width of the flat part 4 formed in the bottom part of the groove portion A where the flat part 4 is provided in the bottom part as the abutting part between the flange 1 and the rib 2 needs to be at least 1 mm or greater. Meanwhile, if the width of the flat part 4 formed in the bottom part of the groove portion A is too broad, a large volume of welding metal is needed to fill the groove portion A. Therefore, it is preferable that the width of the flat part 4 in the groove portion A is 5 mm or smaller.

In the hybrid welding method of laser welding and arc welding for the T-joint in this embodiment, the width of the flat part 4 in the groove portion A where the flat part 4 is provided in the bottom part as the abutting part between the flange 1 and the rib 2 of the T-joint is 2 mm. Also, the flat part 4 in this groove portion A is formed perpendicularly to the abutting surface between the flange 1 and the rib 2. Also, the flat part 4 may be formed to be straight to a center line 31 of the laser beam 3, described later.

It is desirable that the dimension of a groove root part 41 shown in FIG. 2 that is the abutting surface between the flange 1 and the rib 2 forming the T-joint is decided according to welding conditions such as predetermined laser output and welding speed of the laser beam 3. In this embodiment, the dimension of the root part 41 is 12 mm.

After the flange 1 and the rib 2 are assembled to form the T-joint, each of the flange 1 and the rib 2 is fixed with a restraining jig (not shown) so that the groove root part 41 as the abutting surface between the flange 1 and the rib 2 is kept gapless.

The laser beam 3 outputted from a laser oscillator, not shown, is guided by an optical fiber (not shown) and condensed by a focus lens on a laser processing head (not shown). The condensed laser beam 3 is irradiated onto the surface of the flat part 4 in the groove portion A provided on the rib 2.

In the hybrid welding method of laser welding and arc welding for the T-joint in this embodiment, the laser beam 3 for laser welding is irradiated from the side where the flat part 4 in the groove portion A provided on the rib 2 is formed. However, a laser irradiation position 6 shown in FIG. 2 as an action point between the laser beam 3 and the flat part 4 is set in such a way that the distance thereof from an end on the side of the rib 2, of the flat part 4 in the groove portion A (the position where the flat part 4 contacts the flange 1) is half the width of the flat part 4 or greater. Also, the upper limit distance of the laser irradiation position 6 is a position where the irradiated laser beam 3 does not interfere with the wall surface of the groove portion A.

Also, the laser irradiation angle at which the laser beam 3 is irradiated, is set in such a way that the center line 31 of the laser beam 3 passes through the laser irradiation position 6 and a point of intersection 5 between the back-side end of the rib 2 and the face-side of the flange 1, as indicated by a chain dotted line in FIG. 2.

In the hybrid welding method of laser welding and arc welding for the T-joint in this embodiment, both laser welding and arc welding are used to carry out welding. Arc welding involves an arc welding power supply, a shielding gas supply device and a welding wire supply device that are not shown, and a welding torch 100. Also, in the hybrid welding method of laser welding and arc welding for the T-joint in this embodiment, the laser beam 3 is ahead of the arc with respect to the direction of welding. However, the arc may be ahead of the laser beam.

In welding the flange 1 and the rib 2 together, a shielding gas is used to prevent oxidation of molten metal. As the shielding gas, a gas made of at least one or more kinds selected from argon, helium, nitrogen, oxygen, carbon dioxide and the like is used.

Generally, in laser-arc hybrid welding, one kind of shielding gas that is advantageous for stability of arc welding is used. However, if there is a large distance between the laser beam and the arc, two different kinds of shielding gases may be used.

This is because a shielding gas that does not easily generate porosity even when the shielding gas is taken in as a keyhole is formed by irradiation with a laser beam and a shielding gas that stabilizes the arc welding process are not necessarily coincident with each other.

In the hybrid welding method of laser welding and arc welding for the T-joint in this embodiment, an Ar+20% CO₂ gas is used.

FIG. 3 shows the sectional shape of the welded part of the T-joint produced by the hybrid welding method of laser welding and arc welding for the T-joint in this embodiment. Since the groove A where the flat part 4 is provided in the bottom part as the abutting part between the flange 1 and the rib 2 is used in fillet welding of the T-joint, in one-time welding, a welded part 7 where a face-side weld bead 71 is formed by arc welding in the groove portion A on the face-side of the rib 2 is provided, and at the same time, the flange 1 and the rib 2 are welded, penetrating the rib 2, by laser welding in which the laser beam 3 is irradiated. Thus, the welded part 7 where a back-side weld bead 72 with a stable shape is formed on the back-side of the rib 2 is successfully provided.

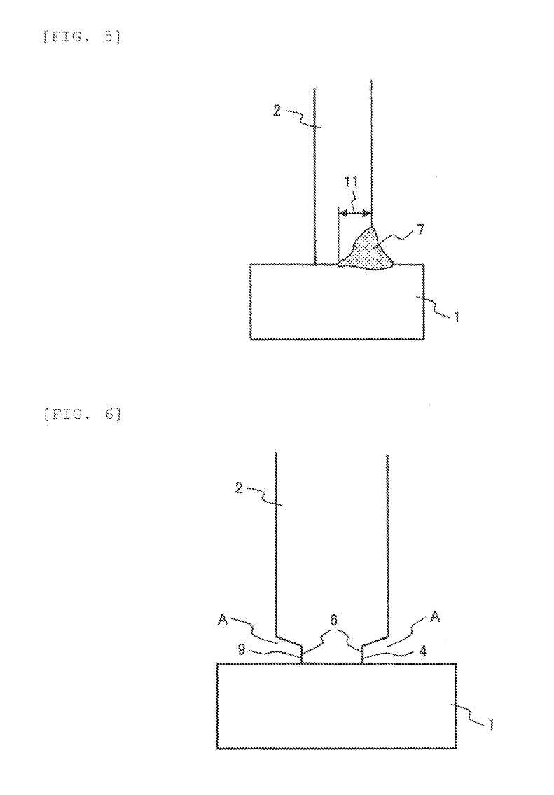

Next, in order to show the effect of the hybrid welding method of laser welding and arc welding for the T-joint of this embodiment, laser-arc composition welding using a single beveled groove that does not have the flat part 4 in the groove portion between the flange 1 and the rib 2 forming the T-joint is carried out as a comparative example, as shown in FIGS. 4 and 5.

FIG. 4 shows the single beveled groove shape in the case where laser-arc hybrid welding is carried out using a single beveled groove 4b without having the flat part 4 in the groove portion between the flange 1 and the rib 2 forming the T-joint as a comparative example. The dimension of the groove root part 41 as the abutting surface between the flange 1 and the rib 2 is 12 mm, which is the same as the groove portion A used in the laser welding method for the T-joint and the hybrid welding method of laser welding and arc welding for the T-joint in the first embodiment.

The laser-arc hybrid welding in the comparative example shown in FIGS. 4 and 5 is carried out, using a laser-arc hybrid welding method with a similar configuration to the configuration used in the laser welding method for the T-joint and the hybrid welding method of laser welding and arc welding for the T-joint in the first embodiment.

In the laser-arc hybrid welding in the comparative example shown in FIG. 4, the single beveled groove 4b without having the flat part between the flange 1 and the rib 2 forming the T-joint is formed, as described above. The result of the welding in the comparative example in the case where laser-arc hybrid welding is carried out in this single beveled groove is shown in FIG. 5.

In the laser-arc hybrid welding in the comparative example shown in FIG. 5, the result of the welding in the comparative example in the case where laser-arc hybrid welding is carried out in the single beveled groove 4b of the T-joint shown in FIG. 4 is shown.

As shown in FIG. 5, in this comparative example, though a welded part 7 where a good face-side weld bead is formed on the face-side of the rib 2 of the welded T-joint is provided, the rib 2 is not penetrated to be molten with the laser beam 3 and therefore the penetration depth 11 of the welded part 7 is insufficient. The abutting part between the flange 1 and the rib 2 is not completely molten and there is a partly luck of fusion in the abutting part between the flange 1 and the rib 2.

On the contrary, in the hybrid welding method of laser welding and arc welding for the T-joint in the present embodiment, since the groove A where the flat part 4 is provided in the bottom part as the abutting part between the flange 1 and the rib 2 is used in fillet welding of the T-joint, as shown in FIG. 3 described above, in one-time welding, the welded part 7 where the face-side weld bead 71 is formed by arc welding in the groove portion A on the face-side of the rib 2 is provided, and at the same time, the flange 1 and the rib 2 are welded, as the laser beam 3 penetrates the rib 2 from the face-side to the back-side. Thus, the welded part 7 where the back-side weld bead 72 with a stable shape is formed on the back-side of the rib 2 is provided. Therefore, deep penetration extending from the face-side to the back-side of the rib 2 is provided on the bonding surface between the flange 1 and the rib 2 of the T-joint, and the welded joint with a stable penetration shape can be provided.

According to this embodiment, as described above, a hybrid welding method of laser welding and arc welding for a T-joint which can avoid an increase in the amount of energy consumed and a fall in welding efficiency, provide deep penetration on the bonding surface between the flange and the rib of the T-joint, and provide a welded joint with a stable penetration shape, can be realized.

### Embodiment 2

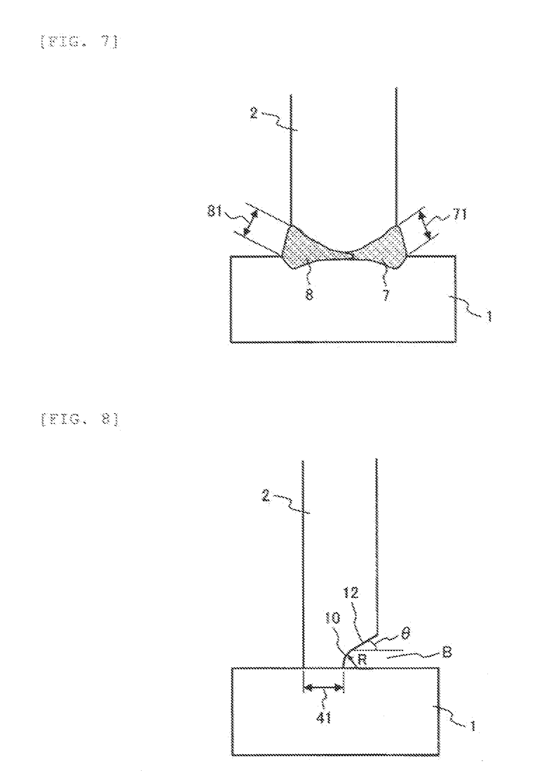

Next, a hybrid welding method of laser welding and arc welding for a T-joint as a second embodiment of the present invention will be described in detail, using FIGS. 6 and 7.

The hybrid welding method of laser welding and arc welding for the T-joint in this embodiment has a basic configuration similar to the hybrid welding method of laser welding and arc welding for the T-joint in the foregoing first embodiment. Therefore, explanation of the similar configuration of the two embodiments is omitted and different parts alone will be described hereinafter.

The hybrid welding method of laser welding and arc welding for the T-joint in this embodiment is an example in which the abutting part between the flange 1 and the rib 2 is welded from both sides of the rib 2.

FIG. 6 shows the groove shape of a T-joint used in the hybrid welding method of laser welding and arc welding for the T-joint as the second embodiment of the present invention. The object to be welded is a T-joint including a rib 2 of a stainless steel plate that is 400 mm long×400 mm wide×30 mm thick welded onto a flange 1 of a stainless steel plate that is 400 mm long×400 mm wide×30 mm thick.

In the bottom part as the abutting part between the flange 1 and the rib 2 of the above T-joint, groove portions A having flat parts 4 and 9 are provided respectively on both sides of the rib 2. The width of each of the flat parts 4 and 9 in each of the groove portions A is 3 mm.

The welding that is carried out is by a laser-arc hybrid welding method with a similar configuration to the hybrid welding method of laser welding and arc welding for the T-joint in the first embodiment. As the shielding gas, an Ar+2% O₂ gas is used, which is different from the first embodiment.

On both sides of the rib 2, the laser irradiation position 6 of the laser beam 3 is a center point in the direction of width of the flat parts 4 and 9 in a lower part of each groove portion A (a point at ½ of the width of the flat parts 4, 9), as in the case of Embodiment 1 shown in FIG. 2.

Also, the laser irradiation angle of the laser beam 3 is similarly set in such a way that an extended line of the center line 31 of the laser beam 3 passes through the laser irradiation position 6 and a point of intersection 5 between the back-side end of the rib 2 and the face-side of the flange 1, as the abutting part between the rib 2 and the flange 1, as in Embodiment 1 shown in FIG. 2.

In the hybrid welding method of laser welding and arc welding in this embodiment, the hybrid welding method of laser welding and arc welding may be carried out in the two grooves A formed on both sides of the rib 2, or the hybrid welding method of laser welding and arc welding may be carried out in one of the grooves A at a time.

FIG. 7 shows the result of the welding in which the hybrid welding method of laser welding and arc welding for the T-joint in this embodiment is applied to the groove portions A having the flat part 4 and the flat part 9 on both sides of the rib 2 forming the T-joint.

As shown in FIG. 7, since the hybrid welding method of laser welding and arc welding is carried out in the two groove portions A from both sides of the rib 2, and a welded part 7 where a face-side weld bead 71 is formed and a welded part 8 where a face-side weld bead 81 is formed are provided, fusion of the fused part 7 and the fused part 8 are connected together in the center. A good penetration shape without having an unmolten part in the abutting part between the rib 2 and the flange 1 is provided and a high-quality welded T-joint without any weld defects is provided.

According to this embodiment, as described above, a hybrid welding method of laser welding and arc welding for a T-joint which can avoid an increase in the amount of energy consumed and a fall in welding efficiency, provide deep penetration on the bonding surface between the flange and the rib of the T-joint, and provide a welded joint with a stable penetration shape, can be realized.

### Embodiment 3

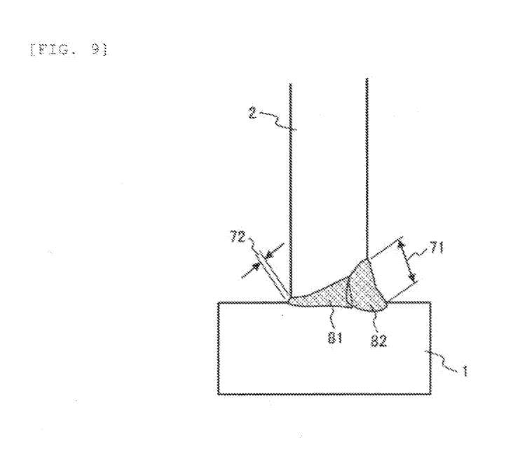

Next, a hybrid welding method of laser welding and arc welding for a T-joint as a third embodiment of the present invention will be described, using FIG. 8.

The hybrid welding method of laser welding and arc welding for the T-joint in this embodiment has a basic configuration similar to the hybrid welding method of laser welding and arc welding for the T-joint in the foregoing first embodiment. Therefore, explanation of the similar configuration of the two embodiments is omitted and different parts alone will be described hereinafter.

The hybrid welding method of laser welding and arc welding for the T-joint in this embodiment is an embodiment in which the same object to be welded as in the first embodiment has a different shape of groove portion.

FIG. 8 shows the shape of a groove portion B in the hybrid welding method of laser welding and arc welding for the T-joint in this embodiment. The groove portion B in this embodiment has a shape of groove portion formed by an arcuate part 10 with a radius R formed at one end of the abutting part between the rib 2 and the flange 1 and an inclined surface 12 having an inclination angle θ continuing to the arcuate part 10.

The radius of curvature of the radius R that forms the arcuate part 10 constituting the groove portion B is 1 mm, and the width of the inclined surface 12 constituting the groove portion B is 1 mm. Also, while the inclination angle θ of the inclined surface 12 as the groove angle of the groove portion B is 20 degrees, the inclination angle θ can be set within a range of 5 to 45 degrees.

Also, the dimension of a root part 41 where the groove of the rib 2 is not set is 12 mm, which is the same as the root part 41 in the case of Embodiment 1.

In the hybrid welding method of laser welding and arc welding for the T-joint in this embodiment, the groove portion B, formed by the arcuate part 10 with the radius R and the inclined surface 12 having the inclination angle θ continuing to the arcuate part 10, is used, as described above.

Then, first of all, laser welding in which a laser beam 3 is irradiated onto the groove portion B is carried out singly, and the root part 41 of the abutting part between the flange 1 and the rib 2 is fused and joined, thus providing a welded part 81 where a back-side bead 72 is formed on the opposite side to the groove portion B.

Next, arc welding called GMAW (Gas Metal Arc Welding) is used to carry out backfill welding in the groove portion B, thus providing a welded part 82 where a face-side bead 72 is formed.

As a result, the welded part 81 and the welded part 82 as shown in FIG. 9 can be provided respectively. That is, in this embodiment, since laser welding is carried out in the groove portion B formed by the arcuate part 10 and the inclined surface 12 having the inclination angle θ continuing to the arcuate part 10, the root part 41 is completely fused and the rib 2 is penetrated to the back-side. Thus, the welded part 81 where the back-side weld bead 72 is formed can be provided on the rib 2.

Also, since arc welding is carried out in the groove portion B, the groove portion B is completely filled back and the welded part 82 where a good face-side weld bead 71 is formed can be provided.

In this embodiment, in the case of laser welding, no weld material is added and the welding is carried out only with laser. However, the welding may be carried out while adding a weld material. Also, the backfill welding in the groove portion B is not limited to GMAW. As a matter of course, GTAW (Gas Tungsten Arc Welding), plasma welding, and laser welding with addition of a weld material may also be employed.

According to this embodiment, as described above, a hybrid welding method of laser welding and arc welding for a T-joint which can avoid an increase in the amount of energy consumed and a fall in welding efficiency, provide deep penetration on the bonding surface between the flange and the rib of the T-joint, and provide a welded joint with a stable penetration shape, can be realized.

### INDUSTRIAL APPLICABILITY

The present invention can be applied to a hybrid welding method of laser welding and arc welding for a T-joint and particularly effective for a hybrid welding method of laser welding and arc welding for a T-joint with a medium-thickness plate and a thick plate.

### REFERENCE SIGNS LIST

1: flange, 2: rib, 3: laser beam, 31: centerline of laser beam, 4: flat part, 41: groove root part, 5: point of intersection between face-side of flange and back-side end of rib, 6: laser irradiation position, 7, 8: welded part, 71: face-side weld bead, 72: back-side weld bead, 81, 82: welded part, 9: flat part, 10: arcuate part, 11: penetration depth, 12: inclined surface, 100: arc welding torch

1. A hybrid welding method of laser welding and arc welding for a T-joint, in which a rib as one member to be welded abuts orthogonally onto a surface of a flange as other member to be welded, the method comprising:
forming a groove portion on a lateral surface of the rib that is an abutting part between the rib and the flange forming the T-joint;
forming a flat part at a bottom part of the groove portion formed in the abutting part between the rib and the flange; and
performing a hybrid welding using both laser welding in which the groove portion with this flat part therein is irradiated with a laser beam, and arc welding, to form a welded part in which a weld bead is formed in the groove portion, so that welding together the flange and the rib forming the T-joint.

2. A hybrid welding method of laser welding and arc welding for a T-joint, in which a rib as one member to be welded abuts orthogonally onto a surface of a flange as other member to be welded, the method comprising:
forming a groove portion on each of lateral surfaces on both sides of the rib that is an abutting part between the rib and the flange forming the T-joint;
forming a flat part at a bottom part of the two groove portions formed in the abutting part between the rib and the flange; and
performing a hybrid welding using both laser welding in which the two groove portions with these flat parts therein are irradiated with a laser beam, and arc welding, to form a welded part in which a weld bead of weld metal is formed in each of the two groove portions, so that welding together the flange and the rib forming the T-joint.

3. The hybrid welding method of laser welding and arc welding for the T-joint according to claim 1 further comprising:
a width of the flat part formed in the bottom part of the groove portion is set to be 1 mm or greater and 5 mm or smaller.

4. The hybrid welding method of laser welding and arc welding for the T-joint according to claim 1 further comprising:
a distance from a point of intersection between the laser beam and the flat part that is a laser irradiation position where the groove portion is irradiated with the laser beam, to an end of the flat part on the rib side, is set to be ½ of the width of the flat part or greater.

5. The hybrid welding method of laser welding and arc welding for the T-joint according to claim 1 further comprising:
a laser irradiation angle at which the groove portion is irradiated with the laser beam is set in such a way that an extended line of a center line of the laser beam passes through the laser irradiation position 6 and a point of intersection between a back-side end of the rib and a face-side of the flange.

6. A hybrid welding method of laser welding and arc welding for a T-joint, in which a rib as one member to be welded abuts orthogonally onto a surface of a flange as other member to be welded, the method comprising:
forming a groove portion on a lateral surface of the rib that is an abutting part between the rib and the flange forming the T-joint;
forming the groove portion formed in the abutting part between the rib and the flange, with an arcuate part and an inclined surface having an inclination angle continuing to the arcuate part; and
performing a hybrid welding using both laser welding in which the groove portion formed with the arcuate part and the inclined surface continuing to the arcuate part is irradiated with a laser beam, and arc welding, to form a welded part in which a weld bead is formed in the groove portion, so that welding together the flange and the rib forming the T-joint.

7. The hybrid welding method of laser welding and arc welding for the T-joint according to claim 6, further comprising:
the inclination angle of the inclined surface of the groove portion formed by the arcuate part and the inclination surface continuing to the arcuate part is set to be 5 to 45 degrees.

8. The hybrid welding method of laser welding and arc welding for the T-joint according to claim 2, further comprising:
a width of the flat part formed in the bottom part of the groove portion is set to be 1 mm or greater and 5 mm or smaller.

9. The hybrid welding method of laser welding and arc welding for the T-joint according to claim 2, further comprising:
a distance from a point of intersection between the laser beam and the flat part that is a laser irradiation position where the groove portion is irradiated with the laser beam, to an end of the flat part on the rib side, is set to be ½ of the width of the flat part or greater.

10. The hybrid welding method of laser welding and arc welding for the T-joint according to claim 2, further comprising:
a laser irradiation angle at which the groove portion is irradiated with the laser beam is set in such a way that an extended line of a center line of the laser beam passes through the laser irradiation position and a point of intersection between a back-side end of the rib and a face-side of the flange.
